(19) United States
(12) Patent Application Publication
(10) Pub. No.: US 2018/0123895 A1
(43) Pub. Date: May 3, 2018

(54) METHOD AND SYSTEM FOR ESTABLISHING AND MANAGING MULTI-DOMAIN VIRTUAL TOPOLOGY (MDVT)

(71) Applicant: ZTE CORPORATION (CHINA), Shenzhen (CN)

(72) Inventors: Bhumip KHASNABISH, Lexington, MA (US); Jie HU, Nanjing (CN)

(73) Assignee: ZTE Corporation, Shenzhen (CN)

(21) Appl. No.: 15/559,496

(22) PCT Filed: Mar. 17, 2016
(86) PCT No.: PCT/CN2016/076604

§ 371 Date: Sep. 19, 2017

(30) Foreign Application Priority Data
Mar. 19, 2015 (CN) PCT/CN2015/074629

(51) Int. Cl. H04L 12/24; H04L 12/46

(52) U.S. Cl. CPC H04L 41/12; H04L 41/20; H04L 12/4641

(57) ABSTRACT

In a method and apparatus for operating a virtual topology, a control entity receives a request to establish a virtual topology between specified endpoints, and the control entity and domain controllers assemble resources forming a virtual topology consistent with the requested virtual topology through domains controlled by the domain controllers between specified endpoints.

### FIELD OF THE INVENTION

The present invention describes generally to Software-Defined Networking. and especially to establishing and managing a Virtual Topology in a hybrid (physical and virtualized) network/service environment.

### BACKGROUND OF THE INVENTION

In general, a topology is an overlay logical connectivity pattern. In case of a Multi-Domain Virtual Topology (MDVT), the intermediate or transit segments of the topology (connectivity pattern) can be in different administrative domains. The topology allows intermediate nodes to quickly route a stream of packets or other data flow from an ingress device to an egress device based on rapidly recognizable headers and/or prefixes without the intermediate node interacting with the data content of the flow. An intermediate node may use, for example, a table, a hash, a stack, etc., for rapid routing.

The ports in a node can be physical or virtual. The ports typically have physical and logical identifiers, and may be identified by physical identifiers, logical identifiers, or both. Examples of physical identifiers include MAC address, Device Identifier, physical location and address, GPS Identifier, etc. Examples of logical identifiers include IP (v4 or v6 or both) address, subnet Identifier, network Identifier, domain name, autonomous system (AS) name/Identifier, etc.

Traditional methods and mechanisms for establishing and managing an end-to-end (ETE) multi-domain topology utilize predominantly physical resources (ports, nodes, links, etc.) and semi-automated processes using a Table (or a database of the connectivity pattern of the topology). In particular, the coordination of different domains to provide path segments that connect end-to-end at a port of each domain, and that provide a consistent Quality of Service, typically requires human intervention. These mostly manual mechanisms are both complex and time consuming and hence prone to human errors.

### BRIEF SUMMARY OF THE INVENTION

This specification focuses on developing a method/system for establishing and managing a Multi-domain Virtual Topology (MDVT) in hybrid (physical and virtualized) network/service environment.

The proposed method uses a Software-Defined Networking (SDN) based architecture. See, for example, B. Khasnabish, J. Hu. and (G Ali, “Virtualizing Network and Service Functions: Impact on ICT Transformation and Standardization,” ZTE Communications Magazine, pp. 40-46, Issue 4 (December), 2013. That architecture can support the flexibility of clear separation of Applications/services, control, virtualization, and forwarding layers.

An embodiment of a method of operating a virtual topology comprises receiving, by a control entity, a request to establish a virtual topology between specified endpoints; and assembling, by the control entity and domain controllers, resources forming a virtual topology consistent with said requested virtual topology comprising alternative paths through domains controlled by the domain controllers between specified endpoints.

An embodiment of an apparatus for operating a virtual topology, comprises a control entity operative to receive a request to establish a virtual topology between specified endpoints; and domain controllers operative to cooperate with said control entity to assemble resources to form a virtual topology comprising alternative paths consistent with the requested virtual topology through domains controlled by the domain controllers between specified endpoints.

In other aspects, the invention provides systems, methods, and computer program products having features and advantages corresponding to those discussed above.

### BRIEF DESCRIPTION OF THE DRAWINGS

Having thus described the invention in general terms, reference will now be made to the accompanying drawings, which are not necessarily drawn to scale, and wherein:

FIG. 1A shows a high-level software defined networking (SDN) based architecture for apps- or service-triggered topology establishment.

FIG. 1B shows virtualization of layer-2 (L2) and layer-3 (L3) network entities—functions and links—for unified control and management.

FIG. 2 describes a system and architecture for Layer-2 (L2) port virtualization and assignment.

FIG. 3 describes a system and architecture for Layer-3 (L3) port virtualization and assignment.

FIG. 4 describes a system and architecture for Layer-2 (L2) link virtualization and assignment.

FIG. 5 describes a system and architecture for Layer-3 (L3) link virtualization and assignment.

FIG. 6 demonstrates centrally controlled concatenation of virtualized topology segments for establishing and managing an end-to-end topology.

FIG. 7 illustrates a high-level topology model for abstraction.

FIG. 8 is a high level representation of topology, both physical and logical.

FIG. 9 shows lifecycle management of physical/virtual ports and links.

### DETAILED DESCRIPTION

Embodiments of the present methods and apparatus will now be described more fully hereinafter with reference to the accompanying drawings, in which some examples of the embodiments are shown. It is to be understood that the drawings and descriptions provided herein may have been simplified to illustrate elements that are relevant for a clear understanding of the present methods and apparatus, while eliminating, for the purpose of clarity, other elements found in typical Software Defined Networking (SDN) systems and methods. Those of ordinary skill in the art may recognize that other elements and/or steps may be desirable and/or necessary to implement the devices, systems, and methods described herein. However, because such elements and steps are well known in the art, and because they do not facilitate a better understanding of the present systems and methods, a discussion of such elements and steps may not be provided herein. The present disclosure is deemed to inherently include all such elements, variations, and modifications to the disclosed elements and methods that would be known to those of ordinary skill in the pertinent art. Indeed, these disclosures may be embodied in many different forms and should not be construed as limited to the embodiments set forth therein, rather, these embodiments are provided by way of example so that this disclosure will satisfy applicable legal requirements. Like numbers refer to like elements throughout.

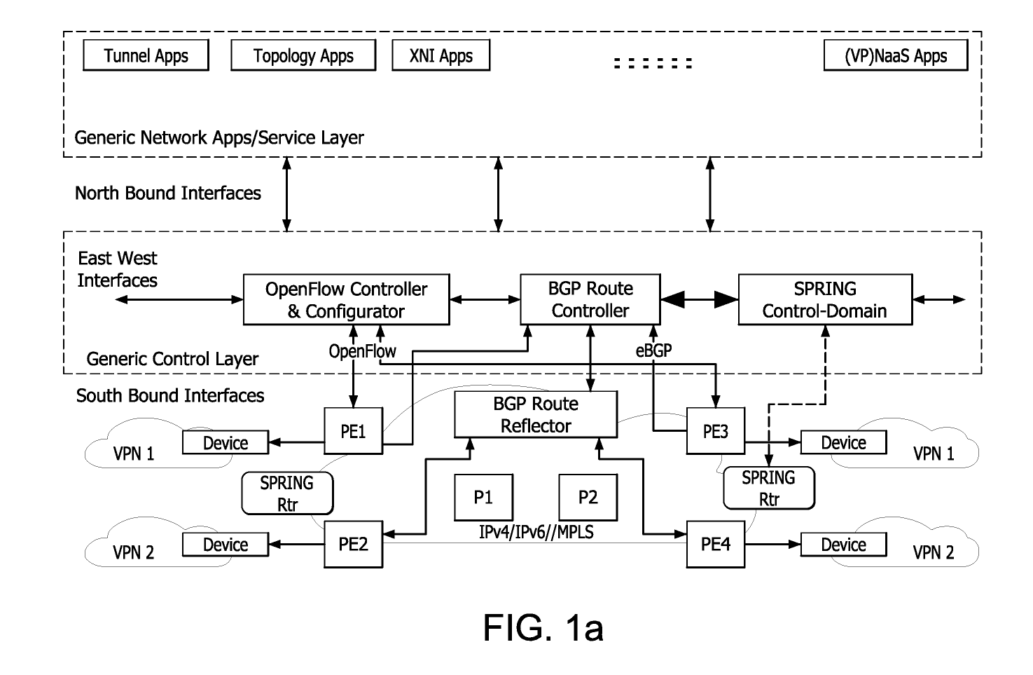

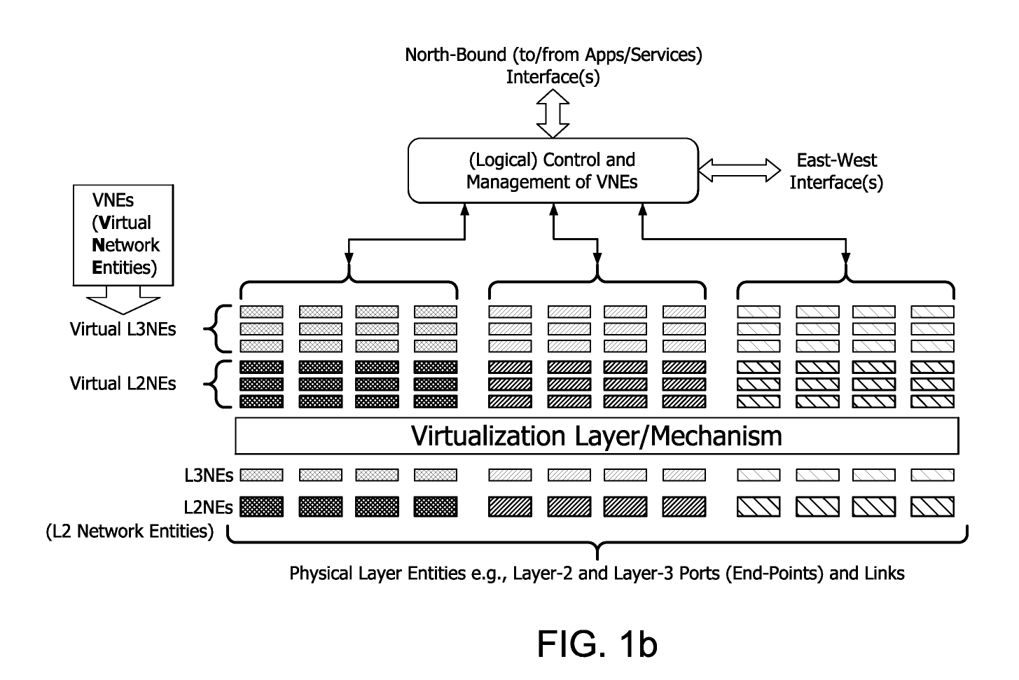

Referring to the drawings, and initially to FIG. 1A, one embodiment of a Software Defined Networking (SDN) based architecture includes a generic network applications and services layer, a generic control layer, and a physical infrastructure layer. The generic control layer is connected to the generic network applications and services layer by “northbound” interfaces (NBIs), and to the physical infrastructure layer by “southbound” interfaces.

The generic network applications and services layer contains applications and services which may include, for example, any of topology apps, topology apps, Any Network Interconnection (XNI), for example, access and Transport, apps, and Networking as a Service (NaaS), including Virtual Private Networking as a Service (VPNaaS) Apps. In an embodiment, the northbound interfaces through which the applications and services in the generic network applications and services layer interact with the elements and entities in the generic control layer are REpresentional State Transfer (REST) systems, which may communicate over HTTP, consistently with IETF RFCs 7230 through 7235 using verbs (GET, POST, PUT, DELETE, etc.) defined to send data to remote servers.

The generic control layer includes various domain controllers which may include any or all of OpenFlow Controller and Configurator. BGP Route Controller, and SPRING Control-Domain. Those domain controllers are mentioned only by way of example, and the generic control layer may include other domain controllers instead of, or in addition to, those mentioned. Each of these domain controllers controls devices in the physical infrastructure layer that belong to its respective domain. As will be discussed in more detail below, a “domain” may be any part of the physical infrastructure layer that can be effectively controlled by a single controller etc. A “domain” may be defined by physical location, ownership, physical interface or interface protocol to the domain controller, or any other expedient constraint. A domain may be physical or virtual. The present embodiment may be a hybrid system, in which some domains are physical and some domains are virtual.

In general, each domain has the capability of forwarding a data flow from one or more ports at one boundary of the domain to one or more ports at another boundary of a domain, or in the case of the domains in which a data flow originates and terminates, has the capability of forwarding the data flow from its origin to one or more ports at a boundary of the domain or from one or more ports at a boundary of the domain to its destination. In general, each domain has at its port or ports a capability of interfacing to a port or ports of another domain and of forwarding a data flow to or from that other domain.

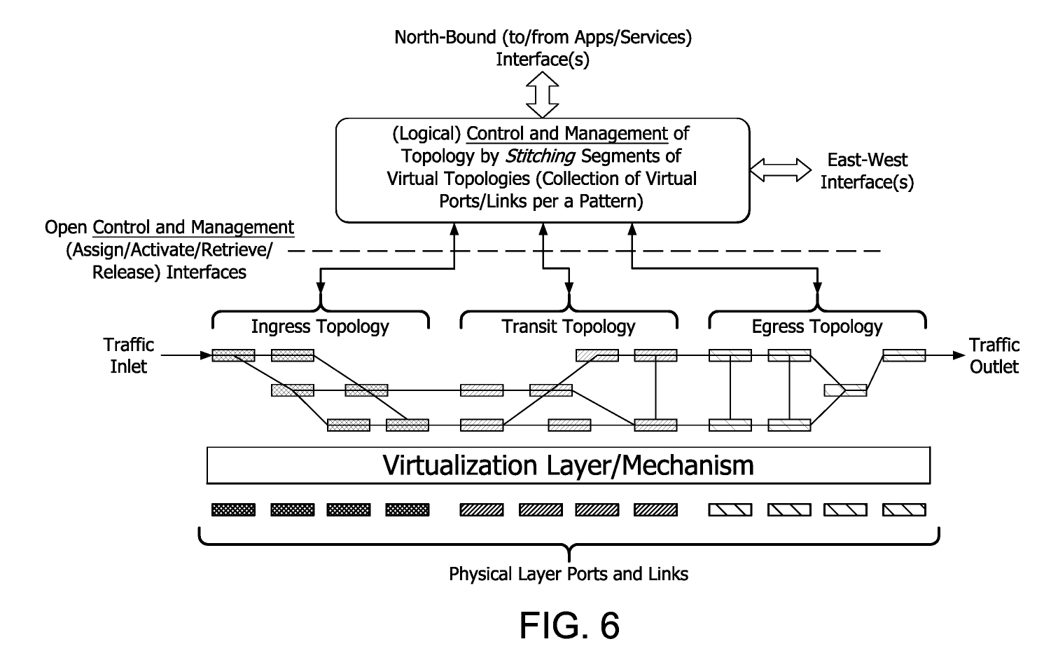

In a topology, as is best shown in FIG. 6, each pair of connecting domains typically has more than one port in use at the common boundary of the two domains, and each domain typically has more than one path for data between any pair of points at which the data can enter and leave that domain.

Each individual domain, and the functionality of each individual domain controller that controls the respective domain, may be conventional and in the interests of conciseness is not further described.

However, as shown in FIG. 1A and as described in more detail below, the various domain controllers within the generic control layer are also linked to one another by “cast-west interfaces.” enabling the controllers to communicate and coordinate their various domains.

By linking domains port-to-port, it is possible to construct a continuous data path from the data source to the data destination. In this embodiment, a “topology” is a continuous network of data channels that is preferably configured for speedy and efficient end-to-end (ETE) data flow. In this embodiment, a Multi-Domain Virtual Topology (MDVT) is a topology that extends over more than one domain, where the intermediate nodes and links can be in different administrative domains, and in which some or all of the domains may be virtual or logical domains rather than domains defined as consisting of contiguous physical infrastructure.

The assignment of ports to a topology may be administered by authorized entities via an authenticated open control interface. This adds desirable flexibility and scalability to establishing and managing an MDVT. FIG. 1B illustrates the virtualization of physical Layer 2 and Layer 3 network entities, such as functions and links, for unified control and management. As shown in FIG. 1B, physical Layer 2 and Layer 3 network entities are grouped into categories, and within each category are virtualized as virtual Layer 2 and Layer 3 network entities. The categories are represented in FIG. 1B and some of the other drawings by different styles of hatching, and may be referred to by color codes such as “Black category,” “Blue category.” and “Green category.” As shown in FIG. 6, the categories are an ingress topology, a transit topology, and an egress topology, but other arrangements are of course possible. One physical entity may be virtualized in more than one way, to allow different modes of management. Several categories may be gathered under the control of a single logical control and management entity in the generic control layer.

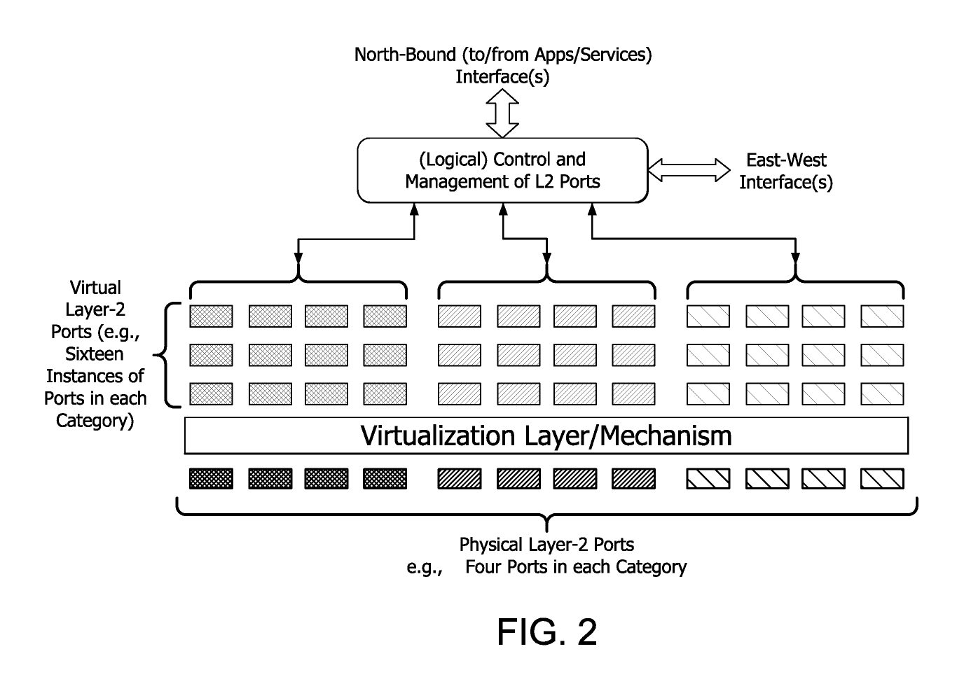

FIG. 2 illustrates a specific embodiment of the architecture of FIG. 1B, for the virtualization and common control and management of multiple categories of physical layer 2 ports.

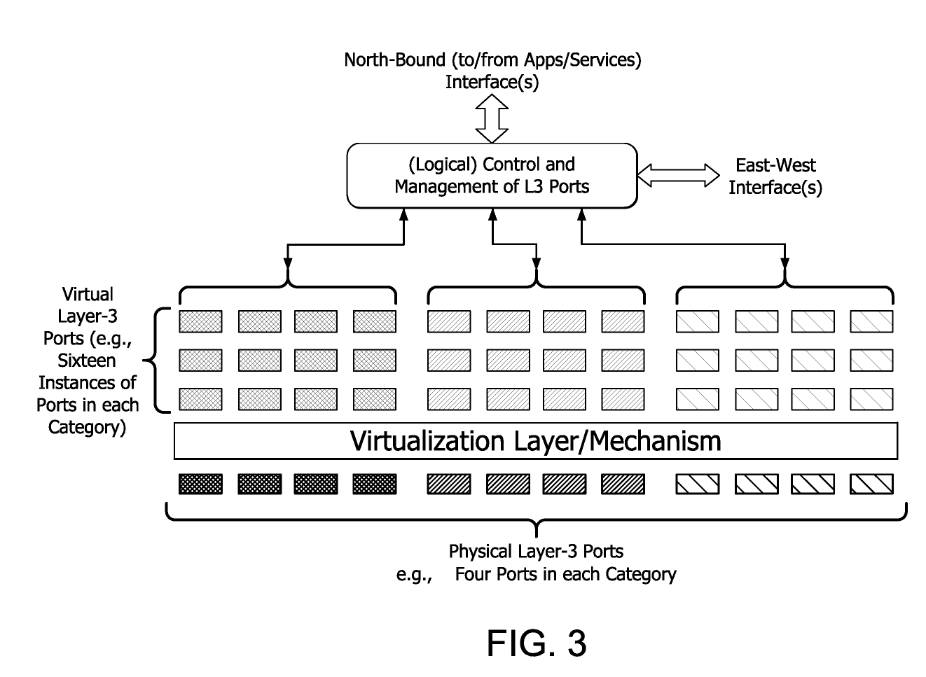

FIG. 3 illustrates a specific embodiment of the architecture of FIG. 1B, for the virtualization and common control and management of multiple categories of physical layer 3 ports.

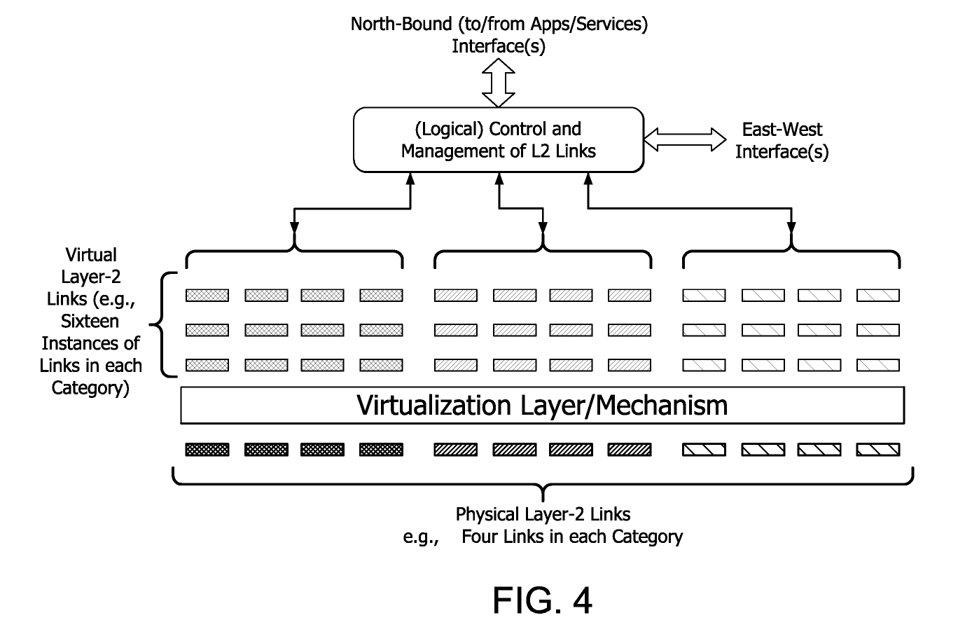

FIG. 4 illustrates a specific embodiment of the architecture of FIG. 1B, for the virtualization and common control and management of multiple categories of physical layer 2 links.

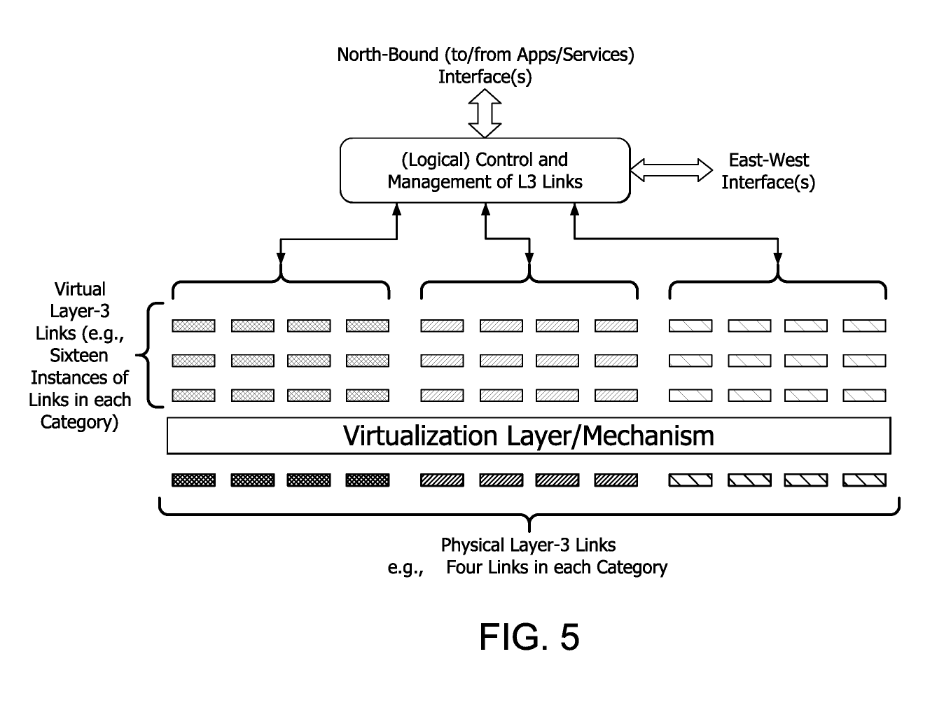

FIG. 5 illustrates a specific embodiment of the architecture of FIG. 1B, for the virtualization and common control and management of multiple categories of physical layer 3 links.

FIG. 6 illustrates a specific instance of the architecture of FIG. 1B, in which the common control and management entity in the generic control layer has assembled and concatenated or stitched, and interconnected, a series of specific virtual network entities to form an end-to-end connectivity pattern or topology from a topology ingress entity or other traffic inlet to a topology egress entity or other traffic outlet (not shown in detail in FIG. 6). Each of the selected virtual entities corresponds to a physical entity, so that the virtual topology represents a physical topology that can transmit physical signals (for example, electrical voltages or radio waves) carrying data. In the interests of simplicity, the virtual topology is shown passing through several virtual network entities of each of three categories (ingress, transit, and egress) in turn. However, this is only an example. As is shown in FIG. 1A, where a control domain is defined by, for example, the type of device controlled, the topology may enter that domain more than once at different geographical locations. In addition, or alternatively, different paths within the overall topology may pass through different transit topology categories in parallel. In addition, or alternatively, there may be more than one transit topology category in series. In the interests of simplicity, the topology is shown as being defined entirely in the virtual network entity layer. However, this is only an example. As is shown in FIG. 1A, the topology may be a hybrid topology, in which some physical entities are controlled directly, and not virtualized.

The use of virtualized resources like ports, links, nodes, etc., is in general preferred, because it can provide additional agility in resources availability and allocations.

The use of a centrally controlled software module in the Controller layer (domain) of the SDN architecture supports desired flexibility in establishing and managing the end-to-end MDVT.

Establishing a Multi-Domain Virtual Topology—an end-to-end pattern where the intermediate nodes and links can be in different administrative domains—calls for temporarily concatenating pre-allocated or available ports and links with the objective of temporarily creating an ETE path from a source to a destination. This helps rapid routing (using table, hash, stack, etc.) of the stream-of-packets or flows based on quickly recognizable headers and/or prefixes.

A software defined networking (SDN) based architecture is used that supports an apps- or service-triggered ETE process for establishing a path (e.g., a topology). A system and architecture are also provided for virtualization and assignment of layer-2 and layer-3 ports and links. A mechanism to support concatenation of virtualized ports and links for establishing and managing an end-to-end topology, including abstraction, is also provided.

The described embodiment makes use of the following features:

The use of an SDN-based architecture allows separation of Apps. Control, Virtualization, and forwarding domains, as shown in FIGS. 1A and 1B.

Both physical and virtualized Layer-2 (L2) and Layer-3 (L3) resources, for example, links, ports, nodes, processes, etc. are used for establishing (virtual) topologies, as shown in FIG. 1B.

Assignment (allocation) and management of both physical and virtual L2 and L3 resources are centralized, e.g., hosted in the Controller layer of the SDN architecture.

Simple connections of virtualized ports and links are used for establishing and managing a topology segment. The connections may be series, parallel and/or a combination of both, based on the pattern obtained from a Table or a database, called topology database.

Simple concatenation (or peering) of virtualized ports and links is used for establishing and managing end-to-end topologies.

Basic lifecycle management of physical/virtual ports and links is applied, with the objective of preventing leakage of residual information, especially if resources (topologies, Apps, services, etc.) are rapidly reassigned to different owners.

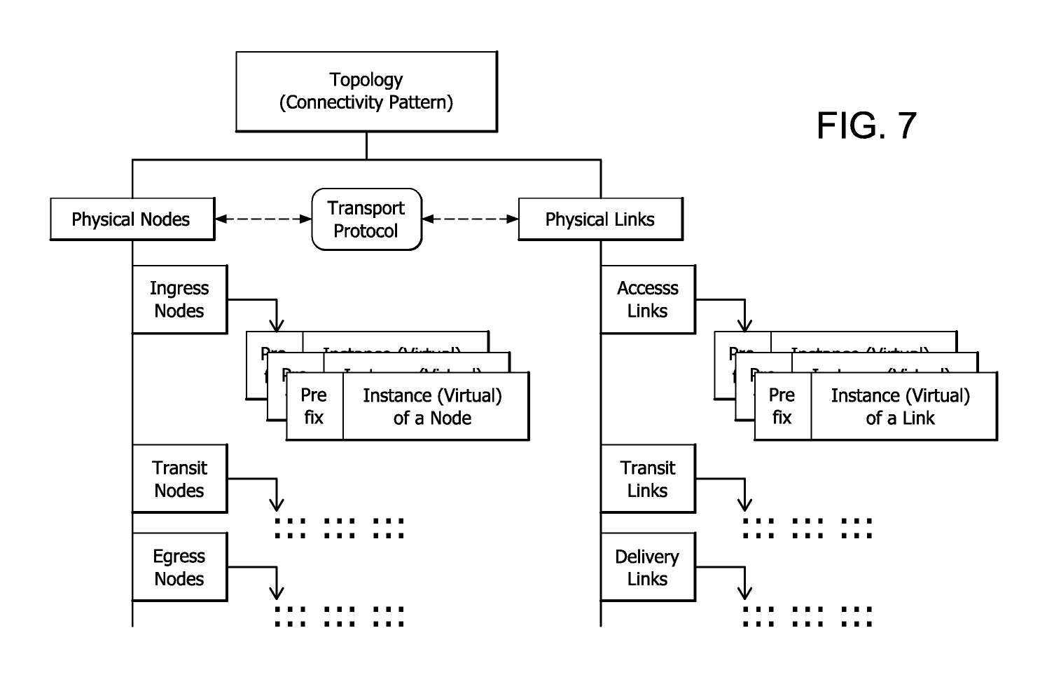

Referring now to FIG. 7, in an embodiment the topology may be represented in terms of physical nodes, connected by physical links, using specified transport protocols. The physical nodes and physical links are grouped into categories, and within each category plural nodes and/or links may exist. As shown in FIG. 7, each node and/or link may have a plurality of instances defined, with distinguishing prefixes. In the interests of clarity, the Transport Protocol is shown only at the general level. However, in a practical embodiment, not only the nodes and links but the individual instances may have individual instances of a transport protocol associated with them.

A single physical node or link may be involved in multiple virtual topologies, and may have different properties in different virtual topologies at the same time. The differences may arise because the customers for different topologies may require, or be permitted, different service levels, for example, for speed, bandwidth, security, continuity, or reliability. The different instances of a node may therefore be different, and may be identified by a distinctive prefix, as illustrated in FIG. 7. For reasons of privacy and/or security, the prefix may be an uninformative label. In particular, it may be desirable to avoid a label that would reveal to an outsider information such as that a particular user or a particular class of traffic is using a particular topology, or that particular inlet and outlet nodes are connected.

The body of the virtual instance may contain detailed specification of the properties of the instance, which may take some time and effort to define satisfactorily. Therefore, in some circumstances, it may be desirable to save the virtual instance as a template that can be used to re-create the same or a similar instance at a future time. Examples are where it may be desired to re-create the same topology at a future time, or where it may be desired to create a new topology having similar service level requirements using some or all of the same or very similar physical nodes or links.

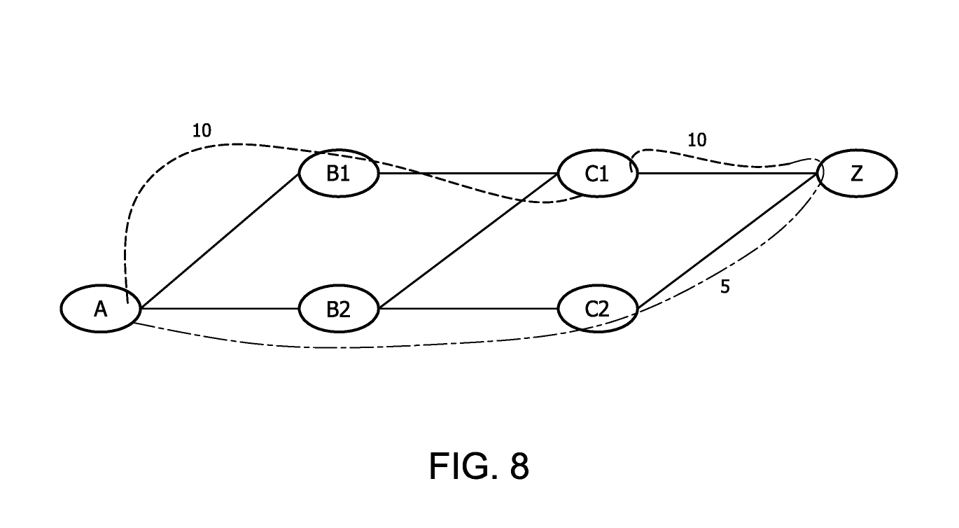

Referring to FIG. 8 and Tables 1 and 2 below, a topology connecting ingress point A to egress point Z may pass through nodes B1 and B2 in transit domain B. and through nodes C1 and C2 in transit domain C.

The connectivity pattern existing in the physical topology may be expressed by the matrix in the following Table 1, where 1 indicates that connectivity exists between two nodes and 0 indicates there is no physical connectivity.

TABLE 1

| | A | B1 | B2 | C1 | C2 | Z |
|---|---|---|---|---|---|---|
| A | 0 | 1 | 1 | 0 | 0 | 0 |
| B1 | 1 | 0 | 0 | 1 | 0 | 0 |
| B2 | 1 | 0 | 0 | 1 | 1 | 0 |
| C1 | 0 | 1 | 1 | 0 | 0 | 1 |
| C2 | 0 | 0 | 1 | 0 | 0 | 1 |
| Z | 0 | 0 | 0 | 1 | 1 | 0 |

In an embodiment, logical links may be defined along paths in the physical topology, and logical links may defined between non-adjacent nodes, bypassing intervening nodes. For example, as shown in FIG. 8, there is a direct path from inlet node A to outlet node Z, running along the links A-B2-C2-Z, but bypassing nodes B2 and C2, and in this example that direct path is supporting 5 logical links. Similarly, there is a direct path from inlet node A to node C1, running along the links A-B1-C1, but bypassing node B1, and in this example that direct path is supporting 10 logical links. The links between adjacent nodes may also be defined as supporting logical links. In this example, the link from C1 to Z is shown as supporting 10 logical links, but in the interests of clarity and simplicity the logical links on other paths between adjacent nodes are not shown. Typically, traffic will preferentially be routed along the direct paths between non-adjacent links, because bypassing an intervening node gives significant savings in both transit time and overhead. Thus, traffic from A to Z will be preferentially routed along the direct path from A to Z bypassing B2 and C2. However, if that path has insufficient capacity, or is temporarily unavailable or less optimal then traffic may be routed via the higher capacity direct path from A to C1 bypassing B1, and must then use the single hop from C1 to Z. Slower mutes, such as A to B2, B2 to C1, C1 to Z, may then be preferred only if the bypassing routes are unavailable.

The connectivity pattern existing in the corresponding logical topology may be expressed by the number of logical links between each pair of nodes, as shown by the matrix in the following Table 2, where a positive integer indicates the number of logical links that exist between two nodes, and 0 indicates there is no logical connectivity. In the interests of simplicity, only the logical links mentioned as preferred in FIG. 8 are included in Table 2, but it will be understood that each of the physical links indicated in Table 1 could have a corresponding entry in Table 2.

TABLE 2

| | A | C1 | Z |
|---|---|---|---|
| A | 0 | 10 | 5 |
| C1 | 10 | 0 | 10 |
| Z | 5 | 10 | 0 |

In Tables 1 and 2, it is assumed that all links are two-way, so if there is a connection from, for example, B2 to C1, there is also a connection from C1 to B2, and the number of logical links is the same in both directions. However, the logical format of Tables 1 and 2 would also support a one-way link, or an unequal number of logical links. The matrix would not then be symmetrical.

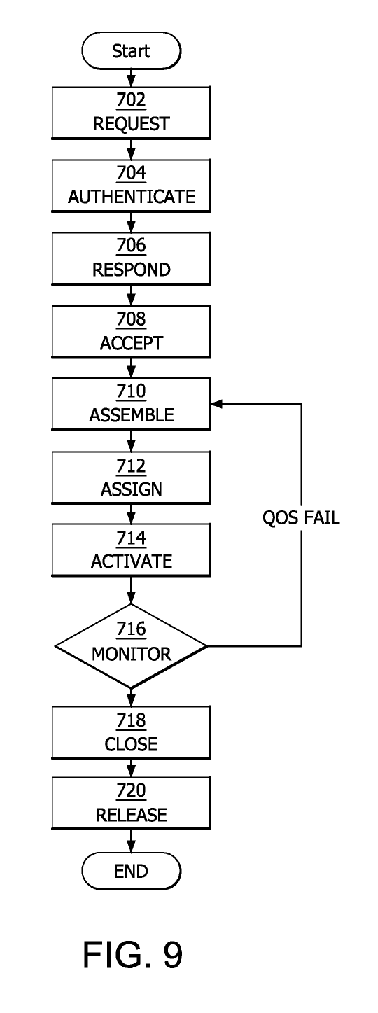

Referring now to FIG. 9, in an example of operation of an embodiment of the described system and method:

In step 702. Request, the user or prospective user (which is, or is acting through, an authorized App/service that needs an ETE topology) sends the request for topology setup to a Control layer/domain Element/entity, as shown in FIGS. 1A. 1B, and 6. The Request specifies a topology from one endpoint (identified by a parameter) to another endpoint. This parameter could be a physical or logical identifier, or both physical and logical identifiers. The physical identifiers may include MAC address, Device Identifier, physical location and address, GPS Identifier, etc. The logical identifiers may include IP (v4 or v6 or both) address, subnet Identifier, network Identifier, domain name, autonomous system (AS) name/Identifier, etc. This Control layer entity logically controls and manages the topology setup by stitching physical and virtual ports and links.

In step 704, Authenticate, the Control domain entity takes any necessary action to authenticate the identity of the requesting entity and the authority of the requesting entity to request the topology.

In step 706, Respond, the Control domain entity responds to the Requesting entity with a Topology ID, Service Type to be supported, and the Ingress and Egress endpoint IDs. These data may be embedded in a Topology name, e.g., “A2Z_Topology-AlwaysOn-10MBPS_HD_Video_Service.” where A and Z are the Ingress and Egress endpoint IDs. The topology may be one-way, two-way, or asymmetric two-way (with bulk data flowing one way and only low-volume control and acknowledgement traffic flowing the other way).

In step 708, Accept, the Requesting App/Service domain entity verifies that the topology data specified are acceptable, and accepts the topology name and type.

In step 710, Assemble, the Control domain entity starts—as shown in FIG. 6—the process of requesting through open interface the individual domain controllers to provide virtual and physical resources (ports, link, nodes, process, etc.). The Control domain entity, and the individual domain controllers negotiating through their east-west interfaces, identify healthy resources, that is to say, resources that are properly functioning and have relevant available capacity.

In step 712, Assign, the resources selected in the Assemble step are assigned to the requested topology. This step includes setting up connectivity and link tables, a routing table, hash, stack, or other configuration to ensure the prompt and reliable routing and forwarding of topology traffic through the intermediate domains.

Once a complete end-to-end topology has been assembled and assigned, in step 714, Activate, the topology resources are activated for the requested Topology service. In some architectures, e.g., the ETSI/ISG NFV Architecture as shown in FIG. 4 of the Network Functions Virtualisation (NFV); Architectural Framework (GS NFV 002, available from www.etsi.org), the Management and Orchestration domain entities may handle the Requests for Assign/Activate/Retrieve/Release of virtual resources for topology setup/release.

In step 716, Monitor, the requesting entity uses the topology to transmit data from the specified ingress endpoint to the specified egress endpoint. The Control domain entity may monitor the topology for compliance with a Service Level Agreement (SLA) or other criterion of acceptable operation. If the topology falls below a minimum criterion, for example, because a domain is overloaded with other traffic and cannot maintain the specified throughput or other Quality of Service requirement, the process may loop back to step 710 and the Control domain entity may repeat the Assemble/Assign/Activate steps to form a new topology, and redirect the traffic to the new topology. Where possible, the new topology is assembled and the traffic is switched over transparently to the end user. The new topology may be share sufficient logical or physical resources with the old topology that some paths remain valid during the switchover. However, because a topology typically provides multiple paths from the specified ingress endpoint to the specified egress endpoint, many QoS issues, especially those of a transient nature, can be accommodated merely by re-routing traffic within the existing topology, so that an explicit reassembly of the topology is less often required than with a single-path configuration.

In step 718. Close, when the original requesting Apps/Service domain entity no longer needs the topology for any service, the requesting Apps/Service domain entity sends a request to close the topology. Alternatively, if the topology, or a specific port or link or other entity or resource, was assigned only for a limited period, the Control domain entity may retrieve that resource when the limited period expires. If the topology is still valid, and only a specific network entity is retrieved, the process may then loop back to step 710, in the same way as if the specific network entity failed QoS monitoring.

In step 720. Release, the Control domain entity directs the domain controllers to release the topology resources. Each domain controller sanitizes the topology resources, for example, by purging any buffers or other temporary storage, and deleting routing table entries. Resources may be tested and fixed if appropriate. All the resources that were utilized by the topology are then released back into the pool of “Healthy” resources available for reassignment.

The use of lifecycle management of the resources like ports, links, nodes, etc., offers desirable privacy for the user and protection of the virtualized resources. Without proper management of the lifecycle for the physical and virtual ports and links, residual information could be leaked to improper users of resources, and that may lead to hacking and/or privacy violation. For example, incorrect reactivation of a buffer that has not been explicitly purged could result in a buffer full of the previous user's data being transmitted to the new user. Incorrect reactivation of a routing table entry that has not been explicitly purged could result in the new user's data being misdirected to the previous user's egress endpoint, or in improper disclosure that there has been communication between the previous user's ingress and egress endpoints.

In other aspects, the invention provides a system and a computer program having features and advantages corresponding to those discussed above.

Although the invention has been described and illustrated in exemplary forms with a certain degree of particularity, it is noted that the description and illustrations have been made by way of example only. Specific terms are used in this application in a generic and descriptive sense only and not for purposes of limitation. Numerous changes in the details of construction and combination and arrangement of parts and steps may be made. Accordingly, such changes are intended to be included in the invention, the scope of which is defined by the claims, and aspects of which include combinations of the features of any two or more of the following claims.

What is claimed as new and desired to be protected by Letters Patent of the United States is:

1. A method of operating a virtual topology, comprising:
receiving, by a control entity, a request to establish a virtual topology between specified endpoints; and
assembling, by the control entity and domain controllers, resources forming a virtual topology comprising plural paths consistent with said requested virtual topology through domains controlled by the domain controllers between specified endpoints.

2. The method of claim 1, further comprising: using said assembled virtual topology or permitting the use of said assembled virtual topology to communicate between said endpoints.

3. The method of claim 2, further comprising monitoring a level of service provided by said assembled virtual topology for said use, and when said level of service becomes inadequate, assembling a new virtual topology and using or permitting the use of said new assembled virtual topology to communicate between said endpoints.

4. The method of claim 2, further comprising: when said using is completed, releasing said resources for other uses.

5. The method of claim 4, further comprising, after said using and before said releasing, sanitizing said resources.

6. The method of claim 1, wherein said assembling comprises defining virtual resources using stored templates.

7. The method of claim 1, wherein said topology comprises links between non-adjacent nodes bypassing intervening nodes.

8. The method of claim 1, wherein said resources comprise resources selected from the group consisting of physical resources and virtual resources.

9. The method of claim 8, wherein said resources comprise physical resources and virtual resources.

10. The method of claim 1, wherein said resources comprise resources selected from the group consisting of OSI model Layer 2 entities and OSI model Layer 3 entities.

11. The method of claim 10, wherein said resources comprise Layer 2 entities and Layer 3 entities.

12. A computer program product comprising instructions operative to cause a general purpose computer to carry out the method of claim 1.

13. A non-volatile computer readable storage medium containing a computer program product according to claim 12.

14. An apparatus for operating a virtual topology, comprising:
a control entity operative to receive a request to establish a virtual topology between specified endpoints; and
domain controllers operative to cooperate with said control entity to assemble resources to form a virtual topology comprising plural paths consistent with said requested virtual topology through domains controlled by the domain controllers comprising plural paths between specified endpoints.

15. The apparatus of claim 14, further comprising apparatus operative to forward communications between ports, said apparatus organized in domains, each said domain controlled by a respective domain controller, wherein said domain controllers and said control entity are operative to cooperate to form said virtual topology by connecting said ports of said domains.

16. The apparatus of claim 14, further comprising a user entity operative to send said request to said control entity, and to use said virtual topology to communicate between said specified endpoints.

17. The apparatus of claim 14, wherein said domain controllers and said control entity are operative to sanitize said resources after use.
